(19) United States
(12) Patent Application Publication
(10) Pub. No.: US 2018/0024023 A1
(43) Pub. Date: Jan. 25, 2018

(54) LIQUID SENSOR

(71) Applicant: ARAM CORPORATION, Osaka-shi, Osaka (JP)

(72) Inventors: Shingo YOSHITOMI, Ikeda-shi (JP); Akira TSUJIOKA, Tokyo (JP); Norikazu KUWASHIRO, Tokyo (JP)

(73) Assignee: ARAM CORPORATION, Osaka-shi, Osaka (JP)

(21) Appl. No.: 15/547,421

(22) PCT Filed: Jan. 29, 2016
(86) PCT No.: PCT/JP2016/052729

§ 371 Date: Jul. 28, 2017

(30) Foreign Application Priority Data
Jan. 29, 2015 (JP) 2015-015680

(51) Int. Cl. G01M 3/16; G01N 27/06

(52) U.S. Cl. CPC G01M 3/16; G01N 27/06

(57) ABSTRACT

A liquid sensor comprising a laminate including a first conductive layer, an insulation layer, and a second conductive layer layered in this order, wherein the laminate has through holes penetrating the first conductive layer, the insulation layer, and the second conductive layer in the lamination direction, and the first conductive layer and the second conductive layer are layers of a resin having electrical conductivity.

### TECHNICAL FIELD

The present invention relates to liquid sensors.

### BACKGROUND ART

Conventionally, liquid sensor for detecting liquid such as blood and urine have been widely required in the fields such as the medical and care fields.

For instance, in the medical field, an accident where a needle inserted into a vein of a patient is withdrawn or the like to cause blood to leak during hemodialysis treatment and thus the patient dies of shock may be caused. In order to prevent such an accident before it happens, use of liquid sensors for detecting leakage of blood has been investigated (for example, see Patent Literatures 1 to 10).

Alternatively, in the elderly care field, utilization of liquid sensors for detecting urine leakage has been investigated (for example, see Patent Literatures 11 and 12).

Alternatively, in the fields other than the medical and care fields, utilization of liquid sensors for detecting water leakage from piping laid in plants and the like, for example, has been investigated (for example, see Patent Literatures 13 to 16).

### CITATION LIST

### Patent Literature

Patent Literature 1: Japanese Unexamined Patent Publication No. 2007-151624
Patent Literature 2: Japanese Patent No. 5587817
Patent Literature 3: Japanese Utility Model Registration No. 3190733
Patent Literature 4: Japanese Patent No. 4368676
Patent Literature 5: Japanese Unexamined Patent Publication No. 2007-502148
Patent Literature 6: International Publication WO No. 2012/020507
Patent Literature 7: International Publication WO No. 2012/111157
Patent Literature 8: Japanese Unexamined Utility Model Publication No. H5-079468
Patent Literature 9: Japanese Unexamined Patent Publication No. 2004-177120
Patent Literature 10: Japanese Unexamined Patent Publication No. 2007-143895
Patent Literature 11: Japanese Unexamined Patent Publication No. 2007-240470
Patent Literature 12: Japanese Patent No. 3334233
Patent Literature 13: Japanese Unexamined Utility Model Publication No. H3-006555
Patent Literature 14: Japanese Unexamined Utility Model Publication No. H4-021852
Patent Literature 15: Japanese Unexamined Utility Model Publication No. H4-036440
Patent Literature 16: Japanese Examined Patent Publication No. H4-045096

### SUMMARY OF INVENTION

### Technical Problem

However, among conventional liquid sensors, for those in which a metal sheet or metal mesh is employed, thinning and weight reduction have been difficult. Additionally, among conventional liquid sensors, a metal layer is produced by vacuum deposition or the like in some cases, but wire breaking is likely to occur on bending or deterioration due to oxidation in such a metal deposition layer. Liquid sensors in which a metal deposition layer is employed also have been required for further improvements in respect that their production process is complex and their production cost is high.

The present invention has been made in consideration of the situation described above, and it is an object of the present invention to provide a liquid sensor of which thinning and weight reduction can be achieved and which can be produced inexpensively and easily.

### Solution to Problem

The present invention provides a liquid sensor comprising a laminate comprising a first conductive layer, an insulation layer, and a second conductive layer layered in this order, wherein the laminate has through holes penetrating the first conductive layer, the insulation layer, and the second conductive layer in the lamination direction, and the first conductive layer and the second conductive layer are layers of a resin having electrical conductivity.

In the liquid sensor of the present invention, when liquid is supplied on the first conductive layer, the liquid passes through the through holes in the laminate to become in contact with the second conductive layer. According to this, the insulation resistance between the first conductive layer and the second conductive layer varies, and this is why the liquid sensor can be used as a liquid sensor. Also, in the liquid sensor of the present invention, layers of a resin having electrical conductivity are used as the first conductive layer and the second conductive layer. Thus, extremely thin conductive layers can be easily formed by a coating method or the like compared with the case where a metal sheet or metal mesh is employed. Accordingly, thinning and weight reduction of the liquid sensor can be achieved. Additionally, the liquid sensor of the present invention is produced more easily compared with the case where a metal deposition layer is employed, and its cost reduction also can be achieved. Furthermore, compared with the case where a metal deposition layer is used, its shape conformability is satisfactory. Accordingly, the liquid sensor is excellent in its texture when brought into contact with a human body and is difficult to be subjected to wire breaking. The liquid sensor of the present invention also has a structure which has through holes penetrating the first conductive layer, the insulation layer, and the second conductive layer, and its production is easy also from this point, which contributes to cost reduction.

The resin having electrical conductivity described above may contain an electrical conductive polymer. In the present invention, an inorganic electrical conductive powder such as carbon black and electrical conductive titanium oxide can be added to the resin having electrical conductivity, but, in the case where the resin having electrical conductivity contains an electrical conductive polymer, the transparency of the conductive layer can be increased. Accordingly, the transparency of the liquid sensor can be improved, and an additional effect by which the status of the portion covered by the liquid sensor can be visually observed more easily also can be obtained. Particularly, from the viewpoint of increasing the transparency of the liquid sensor, it is preferred that the resin having electrical conductivity contain no inorganic electrical conductive powder such as carbon black or electrical conductive titanium oxide.

The laminate described above may further have a second liquid absorptive layer capable of absorbing liquid on the side opposite to the insulation layer of the second conductive layer. According to this, in the case where liquid passes through the through holes in the laminate to reach the second liquid absorptive layer, the liquid is absorbed by the second liquid absorptive layer and becomes likely to flow into the through holes in the laminate. Then, it is possible to improve the conductivity between the first conductive layer and the second conductive layer.

The laminate described above may further have a first liquid absorptive layer capable of absorbing liquid on the side opposite to the insulation layer of the first conductive layer. According to this, the liquid is absorbed by the first liquid absorptive layer and introduced into the through hole. Then, the liquid becomes likely to flow into the through holes and thus it is possible to improve the sensitivity of the liquid sensor.

The basis weight of the first liquid absorptive layer may be 10 to 200 g/m². According to this, it is possible to improve the sensitivity of the liquid sensor.

### Advantageous Effects of Invention

According to the present invention, it is possible to provide a liquid sensor of which thinning and weight reduction can be achieved and which can be produced inexpensively and easily.

### BRIEF DESCRIPTION OF DRAWINGS

FIG. 1 is a perspective view showing one example of a liquid sensor according to First Embodiment.

FIG. 2 Part (a) of FIG. 2 is a cross-sectional view of a main part of the liquid sensor shown in FIG. 1. Part (b) of FIG. 2 is a schematic cross-sectional view showing a state where liquid is supplied to the liquid sensor shown in the part (a) of FIG. 2.

FIG. 3 is a perspective view showing one example of a liquid sensor according to Second Embodiment.

FIG. 4 is a perspective view showing one example of a liquid sensor according to Third Embodiment.

FIG. 5 is a schematic view illustrating a measuring method in Examples.

### DESCRIPTION OF EMBODIMENTS

Hereinafter, preferable embodiments of the present invention will be described in detail with referring to the drawings.

### First Embodiment

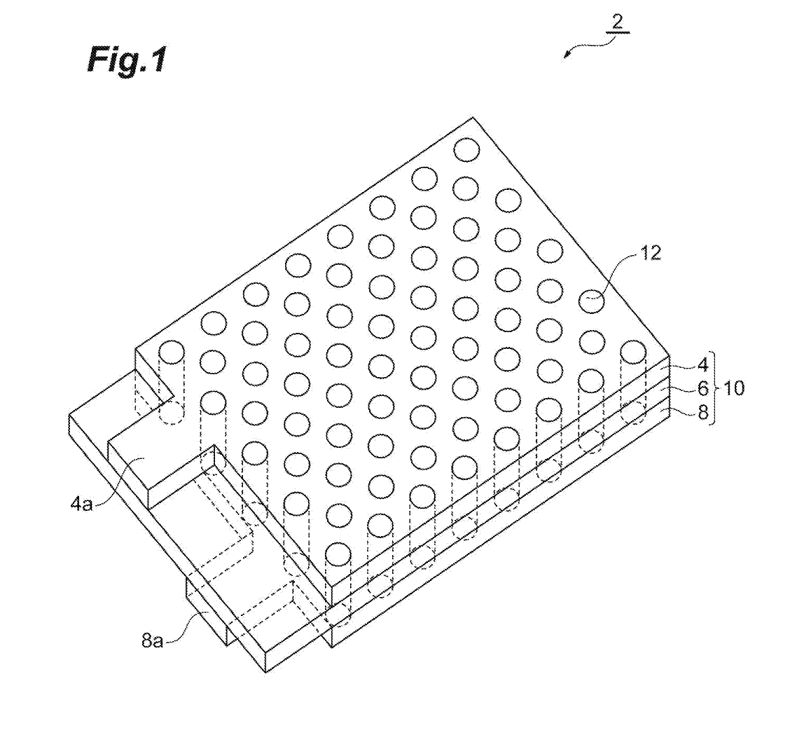

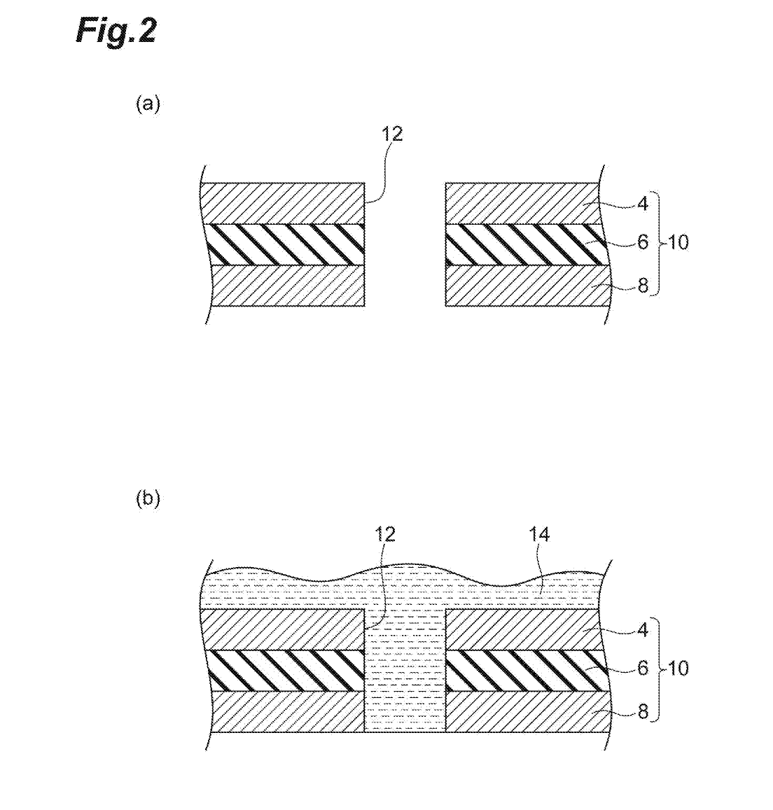

FIG. 1 is a perspective view showing one example of a liquid sensor according to First Embodiment. Part (a) of FIG. 2 is a cross-sectional view of a main part of the liquid sensor shown in FIG. 1, and part (b) of FIG. 2 is a schematic cross-sectional view showing a state where liquid is supplied to the liquid sensor shown in the part (a) of FIG. 2.

The liquid sensor 2 according to First Embodiment comprises a laminate 10 comprising a first conductive layer 4, an insulation layer 6, and a second conductive layer 8 layered in this order, as shown in FIG. 1. The laminate 10 has through holes 12 penetrating the first conductive layer 4, the insulation layer 6, and the second conductive layer 8 in the lamination direction.

The insulation layer 6, which is a layer having an electrical insulation property, has a function of electrically insulating the first conductive layer 4 from the second conductive layer 8 in a state where no liquid is supplied to the liquid sensor 2. As the material of the insulation layer 6, which is not particularly limited, one having flexibility is preferred. Examples of the material of the insulation layer 6 include resins having an insulation property, fabric, and paper. Examples of the resin having an insulation property include polyethylene terephthalate, polyethylene, polypropylene, nylon, polycarbonate, polyvinyl chloride, polyvinylidene chloride, polyimide, silicone rubber, silicone resins, and thermoplastic elastomers. Of these, polyethylene terephthalate is preferred from the viewpoint of being less expensive and excellent in transparency. It is possible to set the thickness of the insulation layer 6 to 0.01 to 10 mm. It is preferred that the thickness of the insulation layer 6 be 50 to 300 μm from the viewpoint of the initial insulation property between the first conductive layer 4 and the second conductive layer 8 and thinning of the liquid sensor 2. It is possible to set the size of the surface of the insulation layer 6 as appropriate depending on applications of the liquid sensor 2, and for example, it is possible to set the length of all the sides of the surface to 10 to 100 cm.

The first conductive layer 4 is a layer of a resin having electrical conductivity. The first conductive layer 4 is provided on one surface of the insulation layer 6 and has a connecting part 4a that connects with an electrode. On the side opposite to the connecting part 4a of the insulation layer 6, the second conductive layer 8 or a connecting part 8a possessed by the second conductive layer 8 is not provided.

The material of the first conductive layer 4 is not particularly limited as long as the material is a resin having electrical conductivity. The surface resistivity of the first conductive layer 4 is not particularly limited, and, from the viewpoint that the sensitivity of the liquid sensor 2 is further improved, is preferably 1×10¹²Ω/□ or less, more preferably 1×10³ to 1×10⁸Ω/□. It is easy to reduce the thickness of the first conductive layer 4 by using a resin having electrical conductivity as the material of the first conductive layer 4. Accordingly, it is possible to achieve thinning, weight reduction, and cost reduction of the liquid sensor 2. Additionally, in the case where the first conductive layer 4 comes in a direct contact with the skin on using the liquid sensor 2, there is provided an advantage where the pleasant texture on the skin is improved as well as a metal allergy is unlikely to be caused by use of a resin having electrical conductivity. The thickness of the first conductive layer 4 is not particularly limited and can be 0.01 to 5 μm, for example. The thickness of the first conductive layer 4 is preferably 0.02 to 4 μm, more preferably 0.03 to 1 μm, and still more preferably 0.05 to 0.1 μm, from the viewpoint of thinning of the liquid sensor 2.

Examples of the resin having electrical conductivity include resins containing an electrical conductive polymer. In the resin having electrical conductivity, it is possible to set the content of the electrical conductive polymer to 50% by mass or more. As the resin having electrical conductivity, resins in which an inorganic electrical conductive powder such as carbon black, electrical conductive titanium oxide, and metal powder is added to a resin having an insulation property also may be used. As the resin having an insulation property, it is possible to use ones as aforementioned. One of the resins having electrical conductivity can be used singly or two or more of these can be used in combination.

Examples of the electrical conductive polymer include polypyrrole, polyaniline, polythiophene, polythienylene vinylene, polyazulene, polyisothianaphthene, polyacetylene, polyphenylene, polyphenylene vinylene, polyacene, polyphenyl acetylene, polydiacetylene, and polynaphthalene. Examples of carbon black include Ketjenblack®, furnace black, channel black, acetylene black, and thermal black.

The second conductive layer 8 is a layer of a resin having electrical conductivity. The second conductive layer 8 is provided on the surface opposite to the first conductive layer 4 of the insulation layer 6 and has the connecting part 8a that connects with an electrode. On the side opposite to the connecting part 8a of insulation layer 6, the first conductive layer 4 or the connecting part 4a is not provided. As the material of the second conductive layer 8, the same material as that of the first conductive layer 4 can be used. It is possible to make the surface resistivity of the second conductive layer 8 similar to that of the first conductive layer 4. The thickness of the second conductive layer 8 is not particularly limited and can be 0.01 to 5 for example. The thickness of the second conductive layer 8 is preferably 0.02 to 4 run, more preferably 0.03 to 1 μm, still more preferably 0.05 to 0.1 μm from the viewpoint of thinning of the liquid sensor 2.

From the viewpoint of increasing the transparency of the liquid sensor 2, it is preferred that the resin having electrical conductivity be a resin not containing an inorganic electrical conductive powder such as carbon black and electrical conductive titanium oxide and it is preferred that the resin be a resin containing an electrical conductive polymer, in the first conductive layer 4 and the second conductive layer 8. Additionally, it is preferred that the insulation layer 6 be a transparent resin. As the liquid sensor 2 has transparency, it is possible to visually observe the status of the portion covered with the liquid sensor 2 easily. For example, in the case where the liquid sensor 2 is used in hemodialysis treatment, it is possible to visually check the status of the needle inserted into a vein of a patient, and it is possible to prevent leakage of blood before it happens. Alternatively, in the case where there is leakage of blood, it is possible to visually check the degree of its leakage. The light transmittance of a light beam at 550 nm in the laminate 10 is preferably 20% or more, more preferably 65% or more from the viewpoint of the visibility of the portion covered with the liquid sensor 2.

It is possible to form the first conductive layer 4 and the second conductive layer 8 by, for example, dissolving or dispersing a resin having electrical conductivity in a solvent such as water or alcohol (for example, propanol and the like) to prepare a coating liquid, coating the coating liquid onto a surface of the insulation layer 6 to form a coating film, and drying to remove the solvent from the coating film. Examples of the method for coating the coating liquid include gravure coating, roll coating, bar coating, spray coating, and dipping. The first conductive layer 4 and the second conductive layer 8 may be provided at once or may be provided separately, on the insulation layer 6.

The through holes 12 are through holes penetrating the first conductive layer 4, the insulation layer 6, and the second conductive layer 8 in the lamination direction, as shown in FIG. 1 and the part (a) of FIG. 2.

A plurality of the through holes 12 is provided in the laminate 10. The through holes 12 are arranged in a triangular arrangement, that is, such that the central axes of the through holes 12 are each placed at an apex of a triangle. It is possible to set the spacing between the through holes 12, as the spacing between central axes, to 10 to 70 mm or 10 to 45 mm, for example. The spacing between through holes 12, as the spacing between central axes, is preferably 13 to 25 mm, from the viewpoint that the sensitivity of the liquid sensor 2 is further improved. Alternatively, it is possible to set the spacing between through holes 12, as a pitch, to 0 to 60 mm, for example. The spacing between through holes 12, as a pitch, is preferably 5 to 30 mm, from the viewpoint that the sensitivity of the liquid sensor 2 is further improved. Incidentally, the pitch means, as for two adjacent through holes 12, the distance between the intersection point of the straight line connecting the central axes and the outer circumference of one of the through holes 12 and the intersection point of the straight line connecting the central axes and the outer circumference of the other of the through holes 12. The through holes 12 are cylindrical, and it is possible to set the hole size of the through holes 12 to 1 to 15 mm or to 0.5 to 7.5 mm, for example. The liquid sensor 2 according to the present invention can sufficiently detect liquid 14 because the liquid 14 flows into the through holes 12 in the laminate 10 whether the hole size of the through holes 12 is 1 mm or further 0.5 mm. The hole size of the through holes 12 is preferably 6 to 12 mm, also preferably 3 to 6 mm, from the viewpoint of an easy inflow of a liquid. It is possible to provide the through holes 12 by a punching method, for example. The through holes 12 may be provided at once by punching the first conductive layer 4, the insulation layer 6, and the second conductive layer 8 at the same hole size by the punching method, from the viewpoint that processing is easy and the sensitivity of the liquid sensor 2 is further improved.

As shown in the part (b) of FIG. 2, when the liquid 14 is supplied to the liquid sensor 2, the liquid 14 flows into the through holes 12, the first conductive layer 4 and the second conductive layer 8 are electrically connected via the liquid 14, and the electrical resistance between the first conductive layer 4 and the second conductive layer 8 are varied. The liquid sensor 2 detects liquid on the basis of the variation of the electric resistance between the first conductive layer 4 and the second conductive layer 8, and thus contact faults are unlikely to occur compared with the case where a conductor circuit is used.

Examples of the liquid 14 include blood, urine, perspiration, infusion solutions, water, rainwater, hydrous alcohol, and aqueous solutions.

As the method for using the liquid sensor 2, first, electrodes are connected to the connecting part 4a of the first conductive layer 4 and the connecting part 8a of the second conductive layer 8. Connection of the electrodes may be carried out by pinching each of the connecting parts 4a and 8a with a clip electrode such that each electrode comes in contact with each of the connecting parts 4a and 8a or by sticking an electrode terminal on each of the connecting parts 4a and 8a with a pressure-sensitive adhesive or the like. Then, a detector detecting the electric resistance and variations in the electric resistance is connected to the liquid sensor 2 via the electrodes connected to the connecting part 4a or 8a. The detector comprises a resistance detecting part to detect the electric resistance, an assessing part to assess the variation in the electric resistance detected, and an informing part to inform the variation in the electric resistance on the basis of the results of assessment of the degree of variation in the electric resistance. The informing part is, for example, a lamp, a buzzer, or the like. In the case where the degree of the variation in the electric resistance is above a certain value, it is possible to notice the variation in the electric resistance by actuation of the informing part.

It is possible to easily check whether the liquid sensor 2 operates normally or not by, for example, checking whether the buzzer connected to the liquid sensor 2 beeps or not when the liquid sensor 2 is touched with a hand wet with the liquid 14 to supply the liquid 14 into the through holes 12. Also among conventional liquid sensors, those employing metal fabric, if moistened with liquid for operation check, require the moistened portion to be dried for allowing the liquid sensor to be reused, whereas the liquid sensor according to the present invention, the moistened portion of which can be easily wiped with tissue paper, fabric, or the like, can be reused without requiring time and is highly convenient.

In the case where the liquid sensor 2 is used in hemodialysis treatment, the liquid sensor 2 is used with a hand or arm of a patient placed on the side of the first conductive layer 4 of the laminate 10. For example, the liquid sensor 2 may be used by being laid under an arm of a patient or may be used by being wrapped around an arm of a patient. If there is leakage of blood caused by withdrawal of a needle inserted into a vein of a patient during hemodialysis treatment, the blood is supplied to the liquid sensor 2, the electric resistance between the first conductive layer 4 and the second conductive layer 8 varies, and the informing part of the detector actuates to thereby enable detection of leakage of blood.

### Second Embodiment

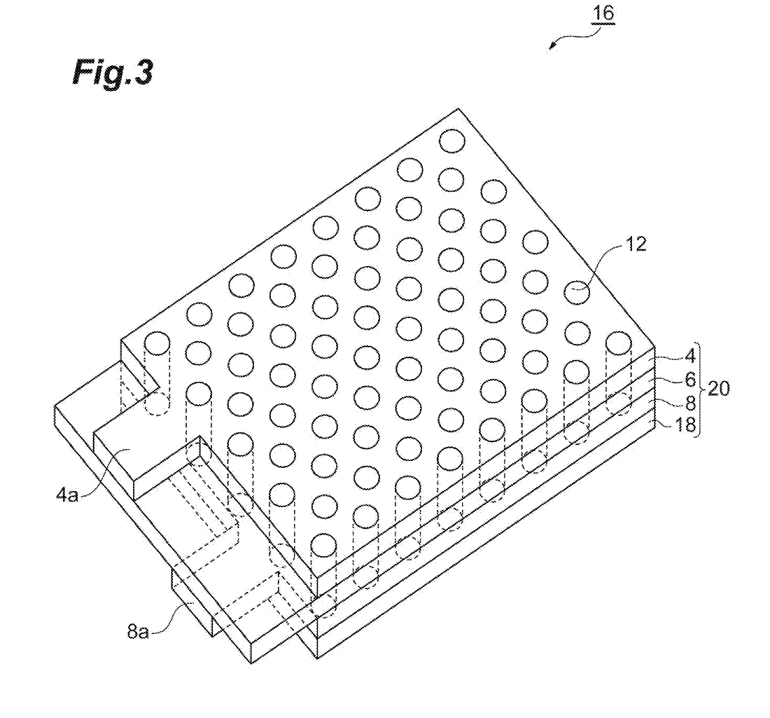

FIG. 3 is a perspective view showing one example of a liquid sensor according to Second Embodiment. In respect to Second Embodiment, only the points different from First Embodiment will be descried. In a liquid sensor 16 shown in FIG. 3, a laminate 20 further has a second liquid absorptive layer 18 capable of absorbing liquid on the side opposite to an insulation layer 6 of a second conductive layer 8. According to this, the second liquid absorptive layer 18 absorbs liquid 14 passed through the through holes 12 in the laminate 20, and thus the liquid 14 becomes likely to flow into the through holes 12 in the laminate 20. Then, it is possible to improve the conductivity between the first conductive layer 4 and the second conductive layer 8 in the case where the liquid sensor 16 comes in contact with the liquid 14.

The second liquid absorptive layer 18 is not particularly limited provided that the layer can absorb liquid. Examples of the second liquid absorptive layer 18 include non-woven fabrics. It is possible to set the thickness of the second liquid absorptive layer 18 to 0.01 to 50 mm.

It is possible to use the liquid sensor according to the present invention for detecting leakage of body fluids such as leakage of blood during hemodialysis treatment and urine leakage and leakage of infusion solution during infusion. Additionally, applications of the liquid sensor according to the present invention are not limited to the medical or care fields, and the liquid sensor also can be applied to applications of general liquid detection, such as detection of rainwater and a water level gauge.

In conventional liquid sensors, those employing a metal sheet or metal mesh have a certain degree of thickness and cause an uncomfortable feeling when in use in contact with a human body. Thus, it is difficult to use such a sensor particularly during sleep. Meanwhile; in the liquid sensor according to the present invention, a layer of a resin having electrical conductivity is employed. Thus, its thinning and weight reduction are easy, and its deformation is also easy. Accordingly, it is possible to greatly reduce the uncomfortable feeling when in use in contact with a human body and it is possible to use the sensor comfortably during sleep or the like. In contrast, there have been those in which a thin metal deposition film has been conventionally employed as the conductive layer, but there are problem that their production process is complex and a production cost is high. In the case where the liquid sensor is used for detection of a fluid in the living body such as blood and urine in the medical or care fields, it is not possible to dispose the sensor after used if the liquid sensor is expensive, and thus the sensor is repeatedly used by conducting sterilization and disinfection. So, a further improvement has been required from the aspect of hygiene. In contrast, the liquid sensor according to the present invention can be disposable because it can be produced very inexpensively and easily despite of being low-profile and light-weight. There is also an advantage where the sensor is excellent from the aspect of hygiene as well as effort and costs of sterilization and disinfection can be saved. There is also an advantage where the sensor can be produced in a free size depending on applications and usage. Additionally, there is also an advantage where the sensor is resizable freely by cutting with scissors or the like to a required size when used.

Hereinabove, the preferable embodiments of the present invention have been described in detail, but the present invention is not intended to be limited to the above embodiments, and various modified embodiments can be employed.

For example, the number, arrangement, and hole size of the through holes 12 in the laminate 10 and the spacing between through holes 12 are not particularly limited, and can be set as appropriate in consideration of the viscosity of a liquid and the like. The shape of the through holes 12 is not particularly limited provided that the shape is a shape through which a liquid can pass and may be a prismatic shape such as a quadrangular prism and a hexagonal prism.

Alternatively, in the laminate 10, the connecting parts 4a and 8a may not be provided. Additionally, in the laminate 10, the second conductive layer 8 or the connecting part 8a possessed by the second conductive layer 8 may be provided on the side opposite to the connecting part 4a of the insulation layer 6, and the first conductive layer 4 or the connecting part 4a may be provided on the side opposite to the connecting part 8a of the insulation layer 6. In the case described above, connection of the electrodes may be performed, for example, by sticking an electrode terminal on the surface of first conductive layer 4 and the surface of the second conductive layer 8 using a pressure-sensitive adhesive, a connecting device or the like such that the electrodes come in contact with each of the first conductive layer 4 and the second conductive layer 8. Connection of the electrodes also may be performed by pinching any position of the laminate 10, or the connecting parts 4a and 8a provided opposite to each other sandwiching the insulation layer 6 therebetween by using a two-electrode-integrated clip electrode, in which a pair of metal clips pinching a connecting part is each connected to a separate electrode and these metal clips are insulated from each other by a plastic spring.

Alternatively, the laminate 10 may be wound in a roll. In this case, the rolled laminate 10 may have perforations at which the laminate can be cut off. According to this, an amount of the laminate 10 required can be cut off and used from the rolled laminate 10. It also becomes easier to use the laminate 10 in a free size.

The second liquid absorptive layer 18, which is usually placed closely on the surface of the second conductive layer 8, may be provided detachably on the surface of the second conductive layer 8. The second liquid absorptive layer 18 may be further provided on the side opposite to the insulation layer 6 of the first conductive layer 4 as the first liquid absorptive layer 24, as described later, and may be form a bag-like shape to cover the entire laminate 20. As a simpler structure, the second liquid absorptive layer 18 (or the first liquid absorptive layer 24) may cover the first conductive layer 4, the insulation layer 6, and the second conductive layer 8 entirely in a bag-like shape.

Additionally, the liquid sensor 16 may further comprise a water stop layer through which no liquid penetrates on the side opposite to the second conductive layer 8 of the second liquid absorptive layer 18. According to this, it is possible to prevent the liquid 14 from flowing on the side of the second liquid absorptive layer 18 of the liquid sensor 16. As the water stop layer, a polyethylene film can be used, for example.

### Third Embodiment

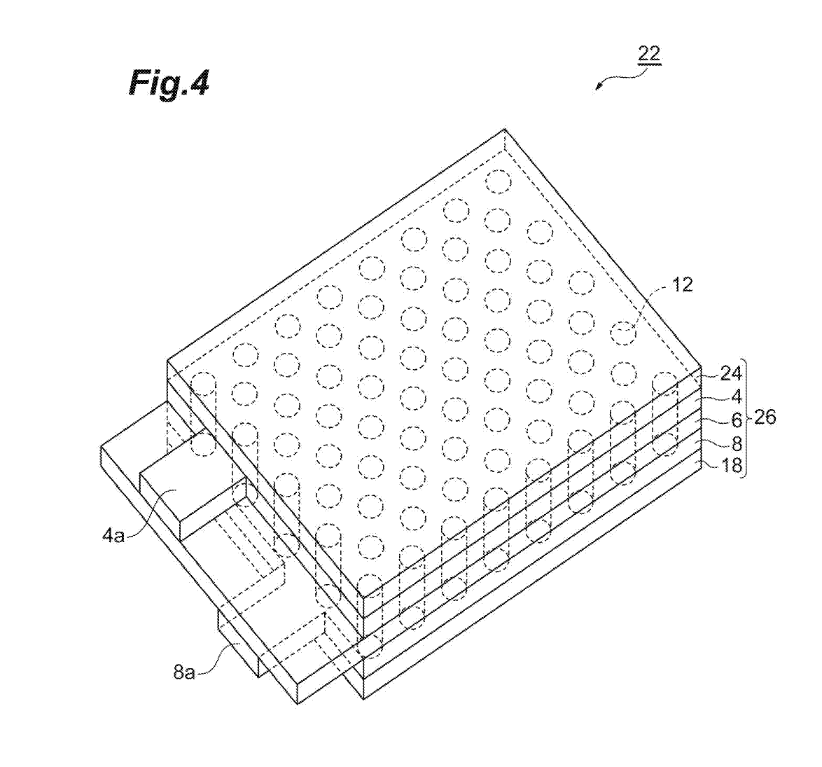

FIG. 4 is a perspective view showing one example of a liquid sensor according to Third Embodiment. In respect to Third Embodiment, only the points different from Second Embodiment will be descried. In a liquid sensor 22 shown in FIG. 4, a laminate 26 further has a first liquid absorptive layer 24 capable of absorbing liquid on the side opposite to an insulation layer 6 of a first conductive layer 4. According to this, in the case where liquid 14 remains on the surface of the liquid sensor 22 due to surface tension and is unlikely to flow into through holes 12 because the amount of the liquid 14 is small, the spacing between through holes 12 are large, the surface of the liquid sensor 22 has unevenness due to the inhomogeneous thickness of the liquid sensor 22 or the like, the first liquid absorptive layer 24 absorbs the liquid 14 and guides the liquid into through holes 12, and thus, the liquid. 14 becomes likely to flow into the through holes 12. Then, it is possible to increase the sensitivity of the liquid sensor 22.

In the case where the liquid sensor 22 is used hemodialysis treatment, the liquid sensor 22 is used with a hand or arm of a patient placed on the side of the first liquid absorptive layer 24 of the laminate 26. There is also an advantage where the liquid sensor 22 can prevent false detection due to flowing of a trace amount of liquid other than blood, such as perspiration of a patient, into the through holes 12 by having the first liquid absorptive layer 24.

The first liquid absorptive layer 24 is not particularly limited provided that the layer can absorb liquid. As the material of the first liquid absorptive layer 24, the same material as that of the second liquid absorptive layer 18 can be used. It is possible to set the thickness of the first liquid absorptive layer 24 to 0.01 to 50 mm. The basis weight of the first liquid absorptive layer 24 is not particularly limited and can be 10 to 200 g/m², for example. The basis weight of the first liquid absorptive layer 24 is preferably 10 to 100 g/m², more preferably 10 to 70 g/m², from the viewpoint that the sensitivity of the liquid sensor 2 is further improved. The basis weight is a mass per unit area.

### EXAMPLES

### Example 1

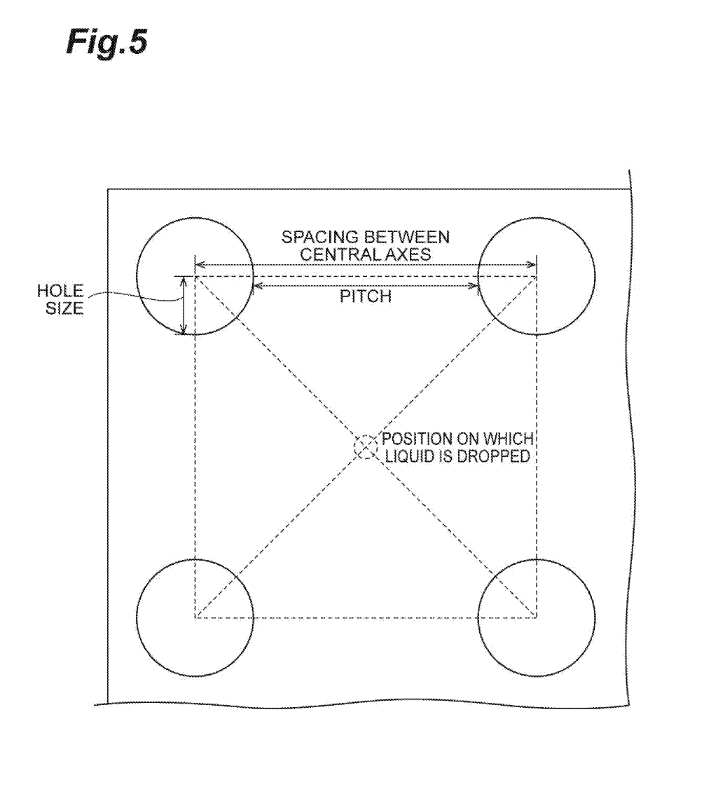

In Example 1, a liquid sensor was produced in accordance with the following procedure. First, a transparent electrical conductive film in which an electrical conductive polymer as a first conductive layer 4, polyethylene terephthalate as an insulation layer 6, and an electrical conductive polymer as a second conductive layer 8 were layered in this order was provided. Subsequently, many cylindrical through holes were provided in the transparent electrical conductive film by the punching method. The through holes were provided in a square arrangement, that is, such that the central axes of the through holes are each placed at an apex of a square (see FIG. 5). The through holes were provided at a constant spacing (pitch). The hole size, pitch, and spacing between central axes of the through holes are shown in Table 1. The spacing between central axes represents the shortest one of the straight-line distances connecting the centers of through holes. In the case of a square arrangement, the spacing between central axes is equivalent to the length of a side of the square. The pitch is equivalent to a value obtained by subtracting the diameter of the through hole (that is, a distance twice the hole size of the through hole) from the spacing between central axes.

### Examples 2 to 4

Liquid sensors of Examples 2 to 4 were produced in the same manner as in Example 1 except that the hole size, pitch, and spacing between central axes were changed as shown in Table 1.

### Examples 5 to 10

Liquid sensors of Examples 5 to 10 were produced in the same manner as in Example 1 except that the hole size, pitch, and spacing between central axes were changed as shown in Table 2 and that a non-woven cloth having a basis weight of 60 g/m² as a first liquid absorptive layer 24 was superposed on the side opposite to the insulation layer 6 of the first conductive layer 4.

### Examples 11 to 16

Liquid sensors of Examples 11 to 16 were produced in the same manner as in Examples 5 to 10 except that the hole size, pitch, and spacing between central axes were changed as shown in Table 3 and that the first liquid absorptive layer 24 was replaced by a non-woven close having a basis weight of 30 g/m².

<Performance Test>

On liquid sensors obtained, their performance was tested in accordance with the following procedure. First, the liquid sensor was connected to a buzzer via the connecting part 4a of the first conductive layer 4 and the connecting part 8a of the second conductive layer 8. As the buzzer, one which became conductive and sounded an alarm when the electric resistance between the first conductive layer 4 and the second conductive layer 8 was 10⁶ Ω/□ or less was used. Subsequently, tap water was dropped on the centers of four through holes arranged in a square (that is, the intersection points of the diagonal lines of the square) as shown in FIG. 5. While the amount of tap water dropped was changed, the smallest amount dropped at which an alarm of the buzzer was sounded (reaction amount) was measured. The results are shown in Tables 1 to 3. It can be said that the less the reaction amount, the higher the sensitivity of the liquid sensor.

TABLE 1

| | Example 1 | Example 2 | Example 3 | Example 4 |
|---|---|---|---|---|
| Hole size (mm) | 2.5 | 2.5 | 5 | 7.5 |
| Pitch (mm) | 20 | 40 | 20 | 20 |
| Spacing between central | 25 | 45 | 30 | 35 |
| axes (mm) | | | | |
| Reaction amount (mL) | 5 | 10 | 3 | 10 |

TABLE 2

| | Exam- | Exam- | Exam- | Exam- | Exam- | Exam- |
|---|---|---|---|---|---|---|
| | ple | ple | ple | ple | ple | ple |
| | 5 | 6 | 7 | 8 | 9 | 10 |
| Hole size (mm) | 2.5 | 2.5 | 5 | 5 | 7.5 | 7.5 |
| Pitch (mm) | 20 | 40 | 20 | 40 | 20 | 40 |
| Spacing between | 25 | 45 | 30 | 50 | 35 | 55 |
| central axes (mm) | | | | | | |
| Reaction amount | 2 | 3 | 2 | 3.5 | 3 | 5.5 |
| (mL) | | | | | | |

TABLE 3

| | Exam- | Exam- | Exam- | Exam- | Exam- | Exam- |
|---|---|---|---|---|---|---|
| | ple | ple | ple | ple | ple | ple |
| | 11 | 12 | 13 | 14 | 15 | 16 |
| Hole size (mm) | 2.5 | 2.5 | 5 | 5 | 7.5 | 7.5 |
| Pitch (mm) | 20 | 40 | 20 | 40 | 20 | 40 |
| Spacing between | 25 | 45 | 30 | 50 | 35 | 55 |
| central axes (mm) | | | | | | |
| Reaction amount | 0.5 | 1.5 | 1 | 2 | 1.5 | 2.5 |
| (mL) | | | | | | |

As clearly seen from the results shown in Table 1, the liquid sensor according to the present invention can control the reaction amount by a combination of the hole size and the pitch (or the spacing between central axes) of the through holes, and it is possible to produce liquid sensors of various sensitivities.

As clearly seen from the results shown in Tables 1 to 3, the sensitivity of the liquid sensor has been improved by providing the first liquid absorptive layer 24. This can be confirmed by comparing Example 1 with Examples 5 and 11, Example 2 with Examples 6 and 12, Example 3 with Examples 7 and 13, and Example 4 with Examples 9 and 15.

As clearly seen from the results shown in Table 2 and Table 3, the sensitivity of the liquid sensor has been improved by reducing the basis weight of the first liquid absorptive layer 24. This can be confirmed by comparing Example 5 with Example 11, Example 6 with Example 12, Example 7 with Example 13, Example 8 with Example 14, Example 9 with Example 15, and Example 10 with Example 16.

### REFERENCE SIGNS LIST

2, 16, 22 Liquid sensor
4 First conductive layer
4a, 8a Connecting part
6 Insulation layer
8 Second conductive layer
10, 20, 26 Laminate
12 Through hole
14 Liquid
18 Second liquid absorptive layer
24 First liquid absorptive layer

1. A liquid sensor comprising a laminate comprising a first conductive layer, an insulation layer, and a second conductive layer layered in this order, wherein
the laminate has through holes penetrating the first conductive layer, the insulation layer, and the second conductive layer in the lamination direction, and
the first conductive layer and the second conductive layer are layers of a resin having electrical conductivity.

2. The liquid sensor according to claim 1, wherein the resin having electrical conductivity comprises an electrical conductive polymer.

3. The liquid sensor according to claim 1, wherein the laminate further has a second liquid absorptive layer capable of absorbing liquid on a side opposite to the insulation layer of the second conductive layer.

4. The liquid sensor according to claim 1, wherein the laminate further has a first liquid absorptive layer capable of absorbing liquid on a side opposite to the insulation layer of the first conductive layer.

5. The liquid sensor according to claim 4, wherein a basis weight of the first liquid absorptive layer is 10 to 200 g/m².

6. The liquid sensor according to claim 3, wherein the laminate further has a first liquid absorptive layer capable of absorbing liquid on a side opposite to the insulation layer of the first conductive layer.
